(19) United States
(12) Patent Application Publication
(10) Pub. No.: US 2025/0274742 A1
(43) Pub. Date: Aug. 28, 2025

(54) TERMINAL DEVICE AND RADIO COMMUNICATION METHOD

(71) Applicant: SOFTBANK CORP., Tokyo (JP)

(72) Inventor: Masashi FUSHIKI, Tokyo (JP)

(21) Appl. No.: 18/858,305

(22) PCT Filed: Apr. 21, 2022
(86) PCT No.: PCT/JP2022/018440

§ 371 Date: Jan. 14, 2025

(51) Int. Cl. H04W 8/24; H04B 7/0413

(52) U.S. Cl. CPC H04W 8/24; H04B 7/0413

(57) ABSTRACT

A terminal device (10) capable of radio communication with a plurality of base station devices (50) includes: an acceptance unit (11) that accepts an enquiry about capability information of the terminal device (10) from one base station device among the plurality of base station devices (50); a notification unit (13) that, when the terminal device (10) can communicate with the plurality of base station devices (50) located at different positions, notifies the one base station device of availability information indicating that a plurality of MIMO methods with different maximum numbers of layers which are available to the terminal device can be used, as the capability information, based on the enquiry; and a receiving unit (15) that receives a radio signal transmitted from the one base station device by using a MIMO method which is set based on the capability information. Consequently, it is possible to provide a radio communication technology for enhancing utilization efficiency of radio communication resources between the terminal device (10) and the base station device(s) (50).

### TECHNICAL FIELD

The present invention relates to a terminal device and a radio communication method.

### BACKGROUND ART

The 3GPP (Third Generation Partnership Project), which is an international standardization organization, is examining NR (New Radio), which is a new radio access technology for 5G (Fifth Generation) cellular communication systems. NR is being studied as a technology for making it possible to implement a wider variety of services than LTE (Long Term Evolution)-Advanced, which is the fourth-generation cellular communication system. For example, regarding NR, implementation requirements are defined for different use scenarios, such as eMBB (enhanced Mobile Broad Band) for realizing high-speed and high-capacity communication, URLLC (Ultra-Reliable and Low Latency Communication) for realizing ultra-reliable and low-delay communication, and mMTC (massive Machine Type Communication) for realizing simultaneous connection of many Internet-of-Things (IoT) devices.

NR adopts carrier aggregation (CA) capable of bandwidth expansion by aggregating (binding), for example, a plurality of 20-MHz frequency bandwidths which are called component carriers (CC) (see NPL1). Also, NR adopts EN-DC (E-UTRA-NR Dual Connectivity) by a base station device eNB (evolved NodeB) in E-UTRA (Evolved Universal Terrestrial Radio Access) and a base station device gNB (g-NodeB) in NR (see NPL2). Regarding EN-DC, there are known a collocated scenario that is a scenario for eNB and gNB, which are located at the same position, to communicate with a terminal device, and a non-collocated scenario that is a scenario for eNB and gNB, which are located at different positions, to communicate with the terminal device.

Meanwhile, regarding NR, the terminal device serves as Type 1 UE and supports the collocated scenario in Intra-band EN-DC and Intra-band NR CA. Moreover, in Intra-band EN-DC, the terminal device serves as Type 2 UE and supports the non-collocated scenario capable of using a 2×2 MIMO method (the maximum number of available MIMO layers is 2) for each CC (see NPL3). In this case, the terminal device (Type 2 UE) which supports the non-collocated scenario causes information to that effect to be included in terminal capability information “UECapabilityInformation” of the terminal device and reports it to the base station device (see NPL1). Incidentally, regarding the Intra-band NR CA, the terminal device does not support the above-described non-collocated scenario.

### CITATION LIST

### Patent Literature

NPL1: 3GPP Specifications “TS 38.306 Ver.16.7.0 (2021 December)”
NPL2: 3GPP Specifications “TS 37.340 Ver. 16.8.0 (2021 December)”
NPL3: 3GPP Specifications “TS 38.133 Ver. 17.5.0 (2022 April)”

### SUMMARY OF THE INVENTION

### Technical Problem

With a conventional radio communication system, the terminal device which supports the non-collocated scenario capable of using the 2×2 MIMO method for each CC adopts only the above-described mechanism of causing the information to that effect to be included in the terminal capability information of the terminal device and notifying the base station device of such terminal capability information as described above.

However, regarding NR, there exists no mechanism of the base station device to check whether a plurality of MIMO methods with different maximum numbers of MIMO layers which are available to the terminal device can be used or not. Specifically speaking, even if the terminal device can use a 4×4 MIMO method (the maximum number of available MIMO layers is 4) in addition to the 2×2 MIMO method, the conventional communication method cannot perform appropriate scheduling according to the MIMO methods which can be used by the terminal device. Therefore, there is fear that the utilization efficiency of communication resources between the terminal device and the base station device may degrade.

The present invention was devised in light of the above-described circumstances and it is an object to provide a radio communication technology for enhancing the utilization efficiency of the radio communication resources between the terminal device and the base station device(s).

### Solution to Problem

A terminal device according to an aspect of the present invention is a terminal device capable of radio communication with a plurality of base station devices, wherein the terminal device includes: an acceptance unit that accepts an enquiry about capability information of the terminal device from one base station device among the plurality of base station devices; a notification unit that, when the terminal device can communicate with the plurality of base station devices located at different positions, notifies the one base station device of availability information indicating that a plurality of MIMO methods with different maximum numbers of layers which are available to the terminal device can be used, as the capability information, based on the enquiry; and a receiving unit that receives a radio signal transmitted from the one base station device by using a MIMO method which is set based on the capability information.

A radio communication method according to an aspect of the present invention is a radio communication method executed by a terminal device capable of radio communication with a plurality of base station devices, wherein the radio communication method includes: accepting an enquiry about capability information of the terminal device from one base station device among the plurality of base station devices; when the terminal device can communicate with the plurality of base station devices located at different positions, notifying the one base station device of availability information indicating that a plurality of MIMO methods with different maximum numbers of layers which are available to the terminal device can be used, as the capability information, based on the enquiry; and receiving a radio signal transmitted from the one base station device by using a MIMO method which is set based on the capability information.

### Advantageous Effects of the Invention

Radio communication technology for enhancing the utilization efficiency of the radio communication resources between the terminal device and the base station device(s) can be provided according to the present invention.

### BRIEF DESCRIPTION OF DRAWINGS

FIG. 1 is a configuration diagram illustrating an example of a schematic configuration of a radio communication system according to an embodiment;

FIG. 2 is a configuration diagram illustrating an example of a hardware configuration of a terminal device and a base station device according to the embodiment;

FIG. 3 is a configuration diagram illustrating an example of a functional block configuration of the terminal device according to the embodiment;

FIG. 4 is a configuration diagram illustrating an example of a functional block configuration of the base station device according to the embodiment;

FIG. 5 is a flowchart illustrating an example of radio signal transmission processing of the terminal device according to the embodiment;

FIG. 6 is a flowchart illustrating an example of the radio signal transmission processing of the terminal device according to the embodiment;

FIG. 7 is a flowchart illustrating an example of the radio signal transmission processing of the terminal device according to the embodiment; and

FIG. 8 is a flowchart illustrating an example of the radio signal transmission processing of the terminal device according to the embodiment.

### DESCRIPTION OF EMBODIMENTS

Embodiments of the present invention will be described below. In the following description of the drawings, identical or similar parts are denoted by identical or similar reference numerals. However, the drawings are schematic. Therefore, specific dimensions, etc. should be determined in light of the following description. Furthermore, it is a matter of course that the drawings include parts regarding which the relationship and ratio of dimensions are different from each other. Furthermore, the technical scope of the present invention should not be understood as being limited to the embodiments.

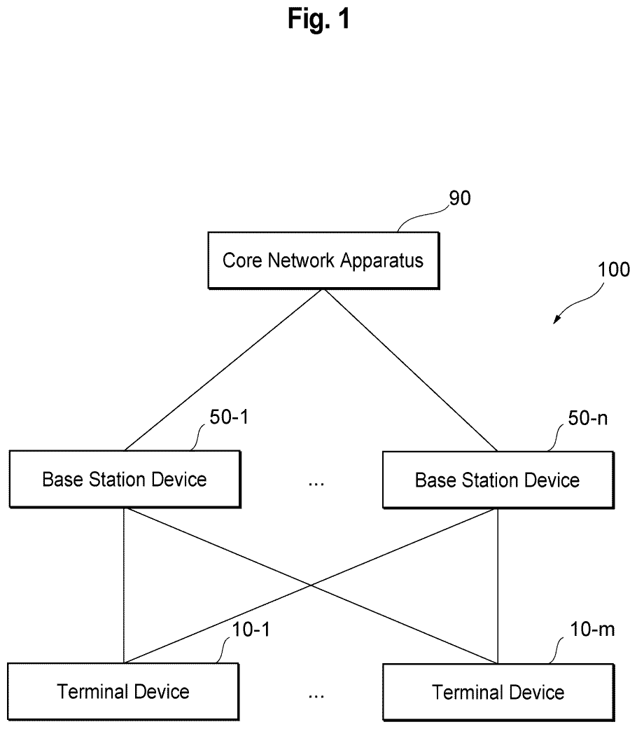

Referring to FIG. 1, an explanation will be provided about a schematic configuration of a radio communication system according to an embodiment. FIG. 1 is a configuration diagram illustrating a schematic configuration of a radio communication system 100. The radio communication system 100 is configured by including terminal devices 10-1 to 10-m, base station devices 50-1 to 50-n, and a core network apparatus 90.

The radio communication system 100 is a radio communication system targeted at, for example, NR (New Radio). Incidentally, the present invention can be applied to any radio communication system as long as it is equipped with at least a terminal device(s) and a base station device(s), and is not limited to a radio communication system targeted at NR. For example, the present invention can be also applied to LTE and LTE-Advanced. Moreover, the present invention can be also applied to a radio communication system which uses NR for part of the radio communication system.

In the following description, LTE and LTE-Advanced may be also called “E-UTRA” (Evolved Universal Terrestrial Radio Access). An area formed by a base station device (a coverage area) is called a “cell” and E-UTRA and NR are cellular communication systems constructed from pluralities of cells. Either method of TDD (Time Division Duplex) or FDD (Frequency Division Duplex) may be applied to the radio communication system according to this embodiment, or a different method may be applied to each cell.

Each of the terminal devices 10-1 to 10-m is wirelessly connected to any one of the base station devices 50-1 to 50-n. Also, each of the terminal devices 10-1 to 10-m may be wirelessly connected with two or more base station devices at the same time from among the base station devices 50-1 to 50-n. Each of the base station devices 50-1 to 50-n can use E-UTRA or NR. For example, the base station device 50-1 may use NR and the base station device 50-n may use E-UTRA and vice versa. The base station device in E-UTRA is called eNB (evolved NodeB) and the base station device in NR is called gNB (g-NodeB).

The radio communication system 100 is, for example, a radio communication system compatible with carrier aggregation (CA) and EN-DC (E-UTRA-NR Dual Connectivity). The carrier aggregation is processing capable of expanding the bandwidth by aggregating (or binding), for example, a plurality of 20-MHz frequency bandwidths which are called “component carriers (CC)”.

With EN-DC (E-UTRA-NR Dual Connectivity), the base station device eNB and the base station device gNB can cooperate with each other and communicate with the terminal device 10. For example, a scenario for eNB and gNB which are located at the same position to communicate with the terminal device 10 is called a “collocated scenario” and a scenario for eNB and gNB which are located at different positions to communicate with the terminal device 10 is called a “non-collocated scenario.”

Under this circumstance, the outline of the radio communication system 100 according to an embodiment of the present invention will be explained below. NR adopts an antenna technology for enhancing throughput of the radio communication. For example, with NR, radio communication using millimeter waves can be executed. When the radio communication is executed by using a relatively high frequency band such as millimeter waves, for example, propagation loss increases. In order to prevent such a problem, there is known a technology to form a beam with a relatively narrow beam width (beamforming). Moreover, NR adopts MIMO (Multiple Input Multiple Output), which is a technology to provide a plurality of antennas on both a transmission side and a reception side and divide transmission data into the plurality of antennas and transfer the divided data parallelly.

On the premise of this MIMO technology, regarding the conventional radio communication system as described above, the 2×2 MIMO method (the maximum number of available MIMO layers is 2) can be used for each component carrier CC and the conventional radio communication system adopts only the mechanism of the terminal device, which supports the non-collocated scenario, to notify the base station device to that effect (for example, Information IA) by including it in the terminal capability information “UECapabilityInformation” of the terminal device.

[Information IA]
intraBandMRDC-WithOverlapDL-Bands-r16
:: = {Supported}

Incidentally, the 2×2 MIMO method is a method of using two antennas for each of the transmission side (the base station device) and the reception side (the terminal device).

However, with the conventional radio communication system, the base station device has no mechanism for checking whether or not a plurality of MIMO methods with different maximum numbers of MIMO layers which are available to the terminal device can be used. Specifically speaking, the conventional radio communication system adopts only the 2×2 MIMO method even when the terminal device can use the 4×4 MIMO method (the maximum number of available MIMO layers is 4) in addition to the 2×2 MIMO method. Accordingly, appropriate scheduling according to the MIMO method which is available to the terminal device cannot be executed by the conventional communication method. Therefore, there is fear that the utilization efficiency of the radio communication resources between the terminal device and the base station device(s) may degrade. Under this circumstance, the 4×4 MIMO method is a method of using four antennas for each of the transmission side (the base station device) and the reception side (the terminal device).

So, the terminal device according to an embodiment of the present invention is a terminal device capable of radio communication with a plurality of base station devices and accepts an enquiry about capability information of the terminal device from one base station device among the plurality of base station devices. When the terminal device can communicate with the plurality of base station devices located at different positions (for example, when the terminal device supports the non-collocated scenario), the terminal device notifies the one base station device of the availability information indicating that the plurality of MIMO methods with different maximum numbers of layers available to the terminal device can be used, as the capability information, based on the enquiry from the base station device. The terminal device receives a radio signal transmitted from the one base station device by using the MIMO method which is set based on the capability information.

Accordingly, the base station device can set the MIMO method to be used for the radio communication with the terminal device based on the capability information of the terminal device and execute appropriate scheduling according to the set MIMO method. Then, the terminal device can receive the radio signal based on a radio resource appropriately allocated from the base station device. Therefore, it is possible to enhance the utilization efficiency of the radio communication resources between the terminal device and the base station device(s). Therefore, the technology according to this embodiment can contribute to the achievement of Goal 9 of the Sustainable Development Goals (SDGs), which aims to “build resilient infrastructure, promote inclusive and sustainable industrialization and foster innovation.”

The respective configurations included by the radio communication system 100 will be explained below more specifically. FIG. 1 illustrates the terminal devices 10-1 to 10-m as m terminal devices (m is an integer equal to or more than 2). In the following description, when these m terminal devices are described without distinguishing them from one another, part of the reference numerals will be omitted and they will be simply referred to as the “terminal device(s) 10.” Moreover, in FIG. 1, the base station devices 50-1 to 50-n are illustrated as n base station devices (n is an integer equal to 2 or more). In the following description, when these n base station devices are described without distinguishing them from one another, part of the reference numerals will be omitted and they will be simply referred to as the “base station device(s) 50.” The terminal device(s) in E-UTRA and NR will be referred to as UE (User Equipment). The base station device gNB in NR may be connected to a terminal device by using a portion of the frequency band it uses (BWP: BandWidth part). In the following description, when a cell(s) is described, it includes BWP.

Examples of the communication terminal(s) 10 can include portable information communication equipment such as IoT devices, smart phones, mobile phones, personal digital assistants (PDAs), tablet terminals, mobile game devices, portable music payers, and wearable terminals. The terminal device 10 is connected with, for example, the base station device 50 on a cell basis and they may be connected by using a plurality of cells, for example, via carrier aggregation. When the terminal device 10 is connected via a plurality of base station devices, that is, in the case of DC (Dual Connectivity), a base station device which is originally connected is called a “master node (MN)” and a base station device(s) which is additionally connected is called a “secondary node(s) (SN).” The base station devices are connected to each other by a base station interface. Moreover, the base station device 50 and the core network apparatus 90 are connected by a core interface. The base station interface is used to exchange a control signal which is necessary for a handover and a cooperative operation between the base station devices.

The core network apparatus 90 has, for example, the base station devices 50 under its control and mainly manages load control between the base station devices and mobility control such as calling (paging) and location registration of the terminal device 10. NR defines an AMF (Access and Mobility Management Function) for mobility management and an SMF (Session Management Function) for session management as a functional group of a control plane (C-plane) in the core network apparatus 90. E-UTRA defines an MME (Mobility Management Entity) corresponding to the AMF.

Incidentally, FIG. 1 illustrates an example in which the core network apparatus 90 is composed of a single apparatus; however, the present invention is not limited to this example. For example, the core network apparatus may be composed of a plurality of apparatuses including a server, a gateway, etc.

In a radio resource control (RRC) layer, the terminal device 10 and the base station device 50 transmit and receive RRC messages to proceed with session processing (also referred to as a “connection sequence”). As the session processing proceeds, the terminal device 10 changes from an idle state (RRC Idle) to a connected state (RRC Connected) of being connected with the base station device 50. The idle state corresponds to a standby status of the terminal device 10.

Moreover, the terminal device 10 and the base station device 50 transmit and receive MAC control elements (MAC CE) in a medium access control (MAC) layer. RRC messages are transmitted as RRC protocol data units (RRC PDU). A common control channel (CCCH), a dedicated control channel (DCCH), a paging control channel (PCCH), a broadcast control channel (BCCH), or a multicast control channel (MCCH) is used as a logical channel to be mapped. A MAC CE is transmitted as a MAC PDU (or MAC subPDU). A MAC subPDU is equivalent to a service data unit (SDU) in the MAC layer plus, for example, an 8-bit header; and a MAC PDU includes one or more MAC subPDUs.

Physical channels and physical signals related to an embodiment of the present invention will be described below. Of the physical channels related to the embodiment of the present invention, an explanation will be provided below about a physical broadcast channel (PBCH), a primary synchronization signal (PSS), a secondary synchronization signal (SSS), a physical random access channel (PRACH), and a physical downlink control channel (PDCCH).

Incidentally, regarding the radio communication system according to the embodiment, there also exist, other than those mentioned above, at least a physical uplink control channel (PUCCH), a physical downlink shared channel (PDSCH), a physical uplink shared channel (PUSCH), a scheduling reference signal (SRS), and a demodulation reference signal (DMRS), but any detailed description about them has been omitted.

### <Physical Broadcast Channel (PBCH)>

The physical broadcast channel (PBCH) is transmitted from the base station device 50 to the terminal device 10 and is used to report common parameters (system information) in cells under the control of the base station device 50. The system information is further classified into a master information block (MIB) and a system information block (SIB). The system information block is further divided into SIB1, SIB2, and so on and then transmitted.

The system information includes information necessary to connect to the cell, and for example, the MIB includes a system frame number and information indicating whether or not camping on to the cell is possible. Moreover, SIB1 includes parameters for calculating cell quality (cell selection parameters), channel information which is common between cells (random access control information, PUCCH control information, and PUSCH control information), and other system information scheduling information.

The physical broadcast channel (PBCH) is periodically transmitted as a set with a synchronization signal block (SSB (or SS/PBSH)) which is composed of a primary synchronization signal (PSS) and a secondary synchronization signal (SSS). The terminal device 10 can acquire cell identifier (cell ID) information and reception timing and measure the signal quality of the relevant cell by receiving the synchronization signal block (SSB).

The system information reported by, for example, the physical broadcast channel (PBCH) is also called “system broadcast information” or “broadcast information.” Moreover, the camp-on to a cell means that a terminal device 10 has completed cell selection and/or cell reselection and the terminal device 10 has entered a state of having selected a cell to monitor the system broadcast information and paging information. The terminal device establishes the aforementioned RRC connection with the base station device 50 which forms the camped-on cell.

### <Primary Synchronization Signal (PSS)>

The primary synchronization signal (PSS) is used by the terminal device 10 to synchronize with a reception symbol timing and a frequency of a downstream signal of the base station device 50. The primary synchronization signal (PSS) is a signal which the terminal device 10 firstly attempts to detect in the procedure of detecting a cell of the base station device 50 (hereinafter also referred to as a “cell search procedure”). Regarding the primary synchronization signal (PSS), three types of signals from “0” to “2” are repeatedly used based on the physical cell ID. Incidentally, the physical cell ID is an identifier of a physical cell, and 504 types of IDs are used in E-UTRA and 1008 types of IDs are used in NR.

### <Secondary Synchronization Signal (SSS)>

The secondary synchronization signal (SSS) is used by the terminal device 10 to detect the physical ID of the base station device 50. Specifically, the secondary synchronization signal (SSS) is a signal used by the terminal device to detect the physical cell ID in the cell search procedure. Regarding the secondary synchronization signal (SSS), 168 types of signals from “0” to “167” are repeatedly used in E-UTRA and 336 types of signals from “0” to “335” are repeatedly used in NR based on the physical cell ID.

### <Physical Random Access Channel (PRACH)>

The physical random access channel (PRACH) is used by the terminal device 10 to transmit a random access preamble to the base station device 50. The physical random access channel (PRACH) is generally used in a state where uplink synchronization is not established between the terminal device 10 and the base station device 50; and is used for transmission timing adjustment information (timing advance) and uplink radio resource requests. Information indicating a radio resource capable of transmitting the random access preamble is transmitted to the terminal by using broadcast information and RRC messages.

### <Physical Downlink Control Channel (PDCCH)>

The physical downlink control channel (PDCCH) is transmitted from the base station device 50 to notify the terminal device 10 of downlink control information (DCI). The downlink control information includes uplink radio resource information (uplink grant (UL grant)) or downlink radio resource information (downlink grant (DL grant)) that can be used by the terminal device 10. The downlink grant is information indicating scheduling of a physical downlink data shared channel (PDSCH). The uplink grant is information indicating scheduling of a physical uplink shared channel (PUSCH). When the physical downlink control channel (PDCCH) is transmitted in response to the random access preamble, the physical downlink data shared channel (PDSCH) indicated by the physical downlink control channel (PDCCH) is a random access response and includes, for example, index information of the random access preamble, transmission timing adjustment information, and uplink grant.

### <Hardware Configuration>

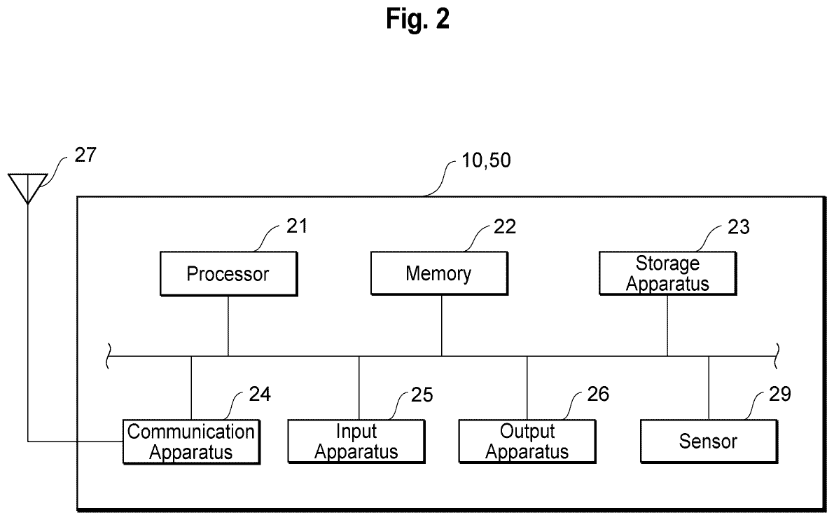

A hardware configuration of the terminal device and the base station device according to an embodiment will be described with reference to FIG. 2. FIG. 2 is a configuration diagram illustrating an example of the hardware configuration of the terminal device 10 and the base station device 50 according to an embodiment.

Referring to FIG. 2, each of the terminal device 10 and the base station device 50 includes, for example, a processor 21, a memory 22, a storage apparatus 23, a communication apparatus 24, an input apparatus 25, an output apparatus 26, an antenna 27, and a sensor 29.

The processor 21 is configured to control the operation of the respective units of the terminal device 10 or the base station device 50. The processor 21 is configured by including, for example, integrated circuits such as a CPU (Central Processing Unit), a DSP (Digital Signal Processor), an ASIC (Application Specific Integrated Circuit), a PLD (Programmable Logic Device), an FPGA (Field Programmable Gate Array), and an SoC (System-on-a-chip).

Each of the memory 22 and the storage apparatus 23 is configured to store programs, data, and so on. The memory 22 is configured from, for example, a ROM (Read Only Memory), an EPROM (Erasable Programmable ROM), an EEPROM (Electrically Erasable Programmable ROM), and/or a RAM (Random Access Memory). The storage apparatus 23 is configured from, for example, storage such as an HDD (Hard Disk Drive), an SSD (Solid State Drive), and/or an eMMC (Embedded Multi-Media Card).

The communication apparatus 24 is configured to perform communication via a wired and/or radio network. The communication apparatus 24 is configured by including, for example, a network card and a communication module. Moreover, the communication apparatus 24 may be also configured by including, for example, an RF (Radio Frequency) front end 243 that performs processing related to an amplifier and a radio signal, and a signal processing unit 241 that performs baseband signal processing.

For example, the RF front end 243 performs D/A (Digital-to-Analog) conversion, modulation, frequency conversion, power amplification, etc. on a digital baseband signal received from the signal processing unit 241 to generate a radio signal to be transmitted from the antenna 27. Moreover, the RF front end 243 performs frequency conversion, demodulation, A/D (Analog to Digital) conversion, etc. on the radio signal received from the antenna 27 to generate a digital baseband signal and transmit it to the signal processing unit 241. The signal processing unit 241 performs processing for converting the digital baseband signal into an IP packet(s) and processing for converting the IP packet(s) into the digital baseband signal.

The input apparatus 25 is configured to input information by a user's operation. The input apparatus 25 is configured by including, for example, a keyboard, a touch panel, a mouse, and/or a microphone.

The output apparatus 26 is configured to output information. The output apparatus 26 is configured by including, for example, a display apparatus such as a liquid crystal display, an EL (Electro Luminescence) display, or a plasma display, and/or a speaker.

The antenna 27 is configured to be capable of emitting (radiating) and receiving electric waves (electromagnetic waves) in one or a plurality of specified frequency bands. The antenna 27 may be an antenna with directionality. The directional antenna 27 varies in gain depending on the direction of the antenna. Incidentally, the antenna 27 may be non-directional, that is, may not have directionality. The non-directional antenna 27 has substantially the same gain from all 360-degree directions in a horizontal plane, in a vertical plane, or in both horizontal and vertical planes.

The antenna 27 is not limited to a single antenna. The terminal device 10 and the base station device 50 may include a plurality of antennas. Each of the terminal device 10 and the base station device 50 includes the plurality of antennas so as to be capable of using the 2×2 MIMO method and the 4×4 MIMO method as described earlier. When the terminal 10 and the base station device 50 include a plurality of antennas, for example, they may be divided into transmission antennas and reception antennas. Moreover, when the plurality of antennas are divided into the transmission antenna(s) and the reception antenna(s), at least either of them may include a plurality of antennas. Incidentally, when the terminal device 10 and the base station device 50 include a plurality of transmission and reception antennas or a plurality of transmission antennas, a beam forming technology described later can be used.

The sensor 29 which the terminal device 10 has includes a sensor(s) for detecting the position, direction, and acceleration of the terminal device 10. The sensor 29 which the terminal device 10 has includes, for example, at least one sensor from among a GPS (Global Positioning System) sensor, a gyro sensor, and an acceleration sensor. On the other hand, the sensor 29 which the base station device 50 has may include, for example, a sensor(s) for detecting environmental information such as the temperature, humidity, weather, or seismic intensity scale at the base station device 50.

### <Functional Block Configuration>

### (Terminal Device)

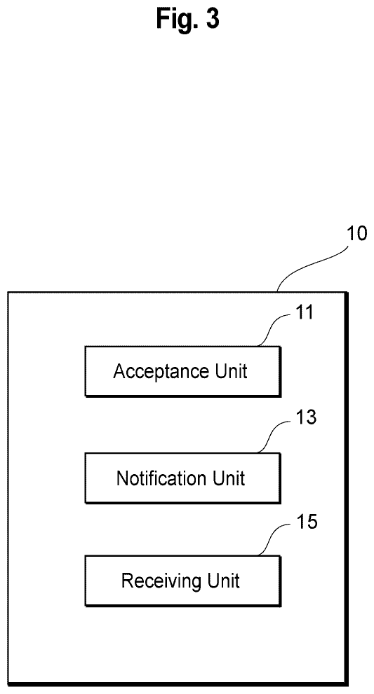

A functional block configuration of a terminal device according to an embodiment will be described with reference to FIG. 3. FIG. 3 is a configuration diagram illustrating an example of the functional block configuration of the terminal device 10 according to an embodiment. Incidentally, FIG. 3 is intended to illustrate functional blocks required in this embodiment and it does not eliminate a case where the terminal device 10 includes functional blocks other than those illustrated.

The terminal device 10 includes, for example, an acceptance unit 11, a notification unit 13, and a receiving unit 15 as the functional blocks.

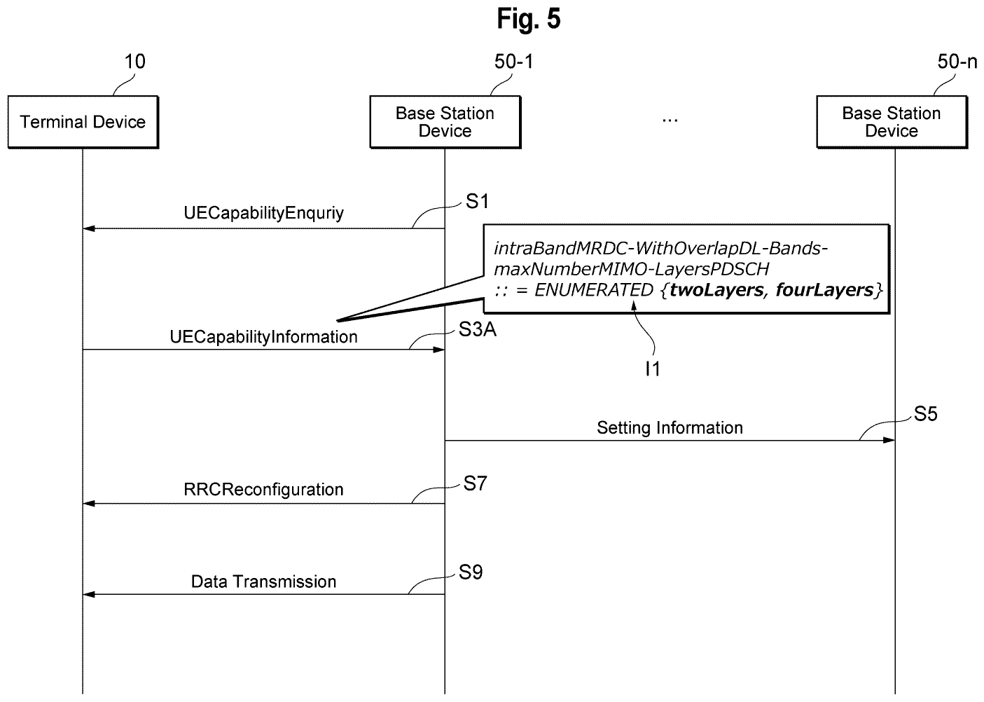

The acceptance unit 11 accepts various types of information from the base station device 50 in FIG. 1. The acceptance unit 11 accepts, for example, an enquiry about the terminal capability information (capability information) of the terminal device 10 from the base station device 50. The terminal capability information includes, for example, “UECapabilityInformation” and the enquiry about the terminal capability information (the capability information) includes a “UECapabilityEnquiry” as illustrated in FIG. 5 to FIG. 8 which will be described later.

The notification unit 13 notifies the base station device 50 of the various types of information in response to the enquiry from the base station device 50. For example, the notification unit 13 returns (or reports) “UECapabilityInformation” to the base station device 50 based on the “UECapabilityEnquriry” received from the base station device 50.

The notification unit 13 notifies the base station device 50 of the availability information indicating that the plurality of MIMO methods with the different maximum numbers of layers available to the terminal device 10 (for example, the 2×2 MIMO method and the 4×4 MIMO method) can be used. The plurality of MIMO methods are arbitrary and are not limited to the 2×2 MIMO method and the 4×4 MIMO method mentioned above, and may further include MIMO methods with other maximum numbers of layers which are available to the terminal device 10.

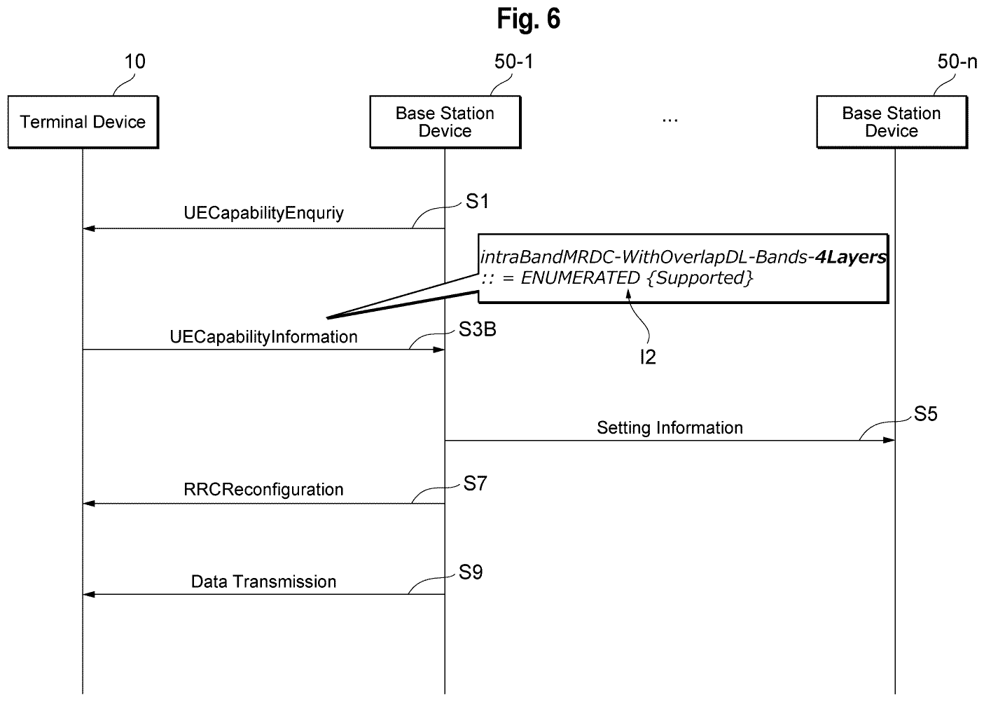

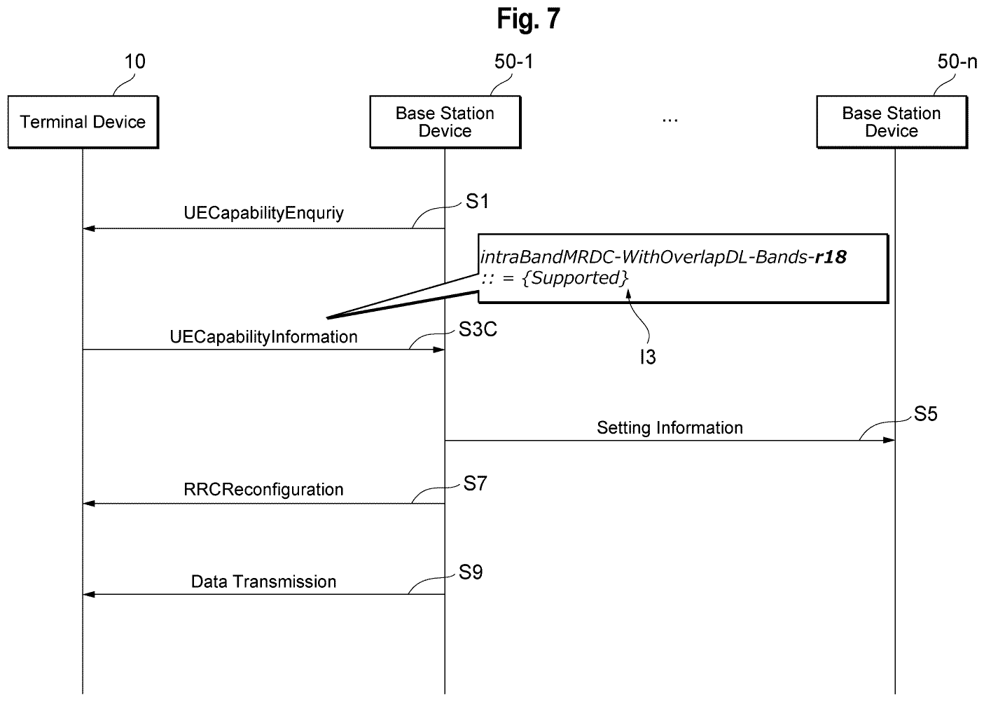

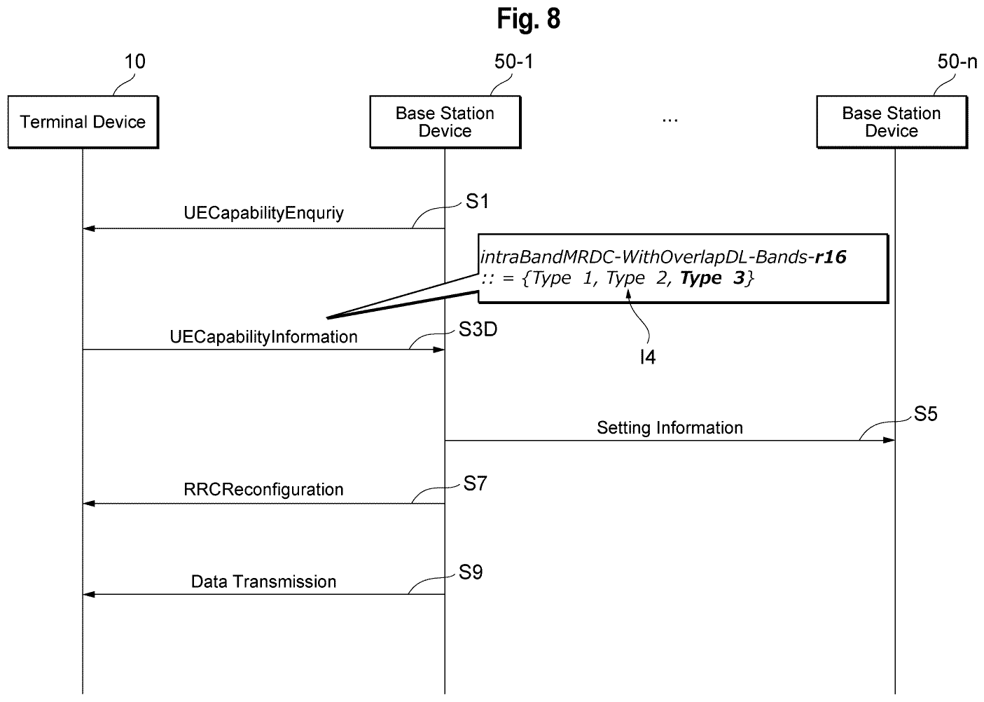

The “availability information” includes, as described later, at least one of information about the maximum number of layers regarding each of the plurality of MIMO methods with different maximum numbers of layers which are available to the terminal device (Information I1 illustrated in FIG. 5), information indicating the plurality of MIMO methods with the different maximum numbers of layers which are available to the terminal device (Information I2 illustrated in FIG. 6), and type information indicating that the terminal device 10 is a terminal device of a specific type capable of using the plurality of MIMO methods (Information I3 illustrated in FIG. 7 and Information I4 illustrated in FIG. 8).

The notification unit 13 is only required to notify the base station device 50 of the availability information and the form regarding the notification is arbitrary. There is no limitation to the notification form for the notification unit 13 to report the availability information as “UECapabilityInformation,” and the availability information may be reported as other information.

The receiving unit 15 receives a radio signal transmitted from the base station device 50. For example, the receiving unit 15 receives a radio signal transmitted by using the MIMO method which is set by the base station device 50 based on the terminal capability information. When the MIMO method which is suited for the terminal capability of the terminal device 10 is set, the base station device 50 executes access control processing for transmitting the radio signal to the terminal device 10 (for example, CA processing and MIMO processing). The receiving unit 15 receives the radio signal which is transmitted as a result of the execution of the access control processing by the base station device 50.

Incidentally, the acceptance unit 11, the notification unit 13, and the receiving unit 15 may be implemented by, for example, the communication apparatus 24 illustrated in FIG. 2 or may be implemented by the processor 21 in addition to the communication apparatus 24 by executing a program(s) stored in the storage apparatus 23. When the processor 21 executes a program, the program may be stored in a storage medium. The storage medium storing the relevant program may be a non-transitory computer-readable storage medium. The non-transitory storage medium is not particularly limited, but may be, for example, a storage medium such as a USB (Universal Serial Bus) memory or a CD-ROM (Compact Disc ROM).

### (Base Station Device)

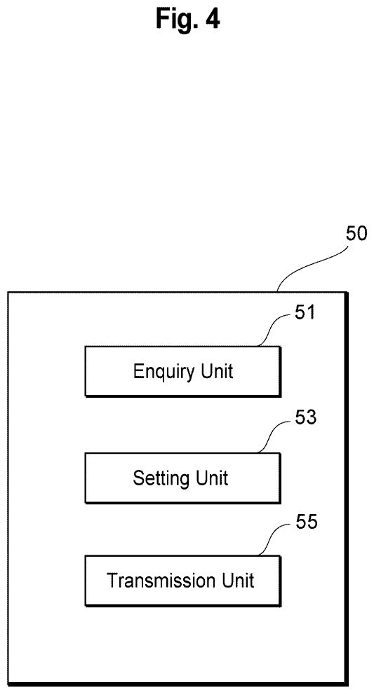

A functional block configuration of the base station device according to an embodiment will be described with reference to FIG. 4. FIG. 4 is a configuration diagram illustrating an example of the functional block configuration of the base station device 50. Incidentally, FIG. 4 is to show functional blocks required in the description of this embodiment and it does not eliminate a case where the base station device 50 includes functional blocks other than those illustrated.

The base station device 50 includes, for example, an enquiry unit 51, a setting unit 53, and a transmission unit 55 as the functional blocks.

The enquiry unit 51 transmits the “UECapabilityEnquiry” to enquire about the terminal capability information “UECapabilityInformation” of the terminal device 10. The enquiry unit 51 receives the terminal capability information as an answer from the terminal device 10.

The setting unit 53 sets, for example, the MIMO layer for each CC upon the CA based on the terminal capability information of the terminal device 10 which is received by the enquiry unit 51. Moreover, the setting unit 53 allocates a radio resource for, for example, downlink CA processing to the terminal device 10 based on the terminal capability information of the terminal device 10 which is received by the enquiry unit 51.

The transmission unit 55 transmits information about the MIMO layer of each CC upon the downlink CA, which is set by the setting unit 53, as “RRCReconfiguration” to the terminal device 10. Moreover, the transmission unit 55 executes access processing for transmitting the radio signal from the base station device 50 to the terminal device 10 (for example, the CA processing and the MIMO processing).

Incidentally, the enquiry unit 51, the setting unit 53, and the transmission unit 55 may be implemented by, for example, the communication apparatus 24 illustrated in FIG. 2 or may be implemented by the processor 21 in addition to the communication apparatus 24 by executing a program(s) stored in the storage apparatus 23. When the processor 21 executes a program, the program may be stored in a storage medium. The storage medium storing the relevant program may be a non-transitory computer-readable storage medium. The non-transitory storage medium is not particularly limited, but may be, for example, a storage medium such as a USB (Universal Serial Bus) memory or a CD-ROM (Compact Disc ROM).

### <Radio Signal Transmission Processing>

### Example 1

An explanation will be provided about Example 1 of the radio signal transmission processing of the terminal device according to the embodiment with reference to FIG. 5. Example 1 of the radio signal transmission processing is based on the premise that it is an example of the case where the plurality of base station devices 50-1 . . . 50-n support the non-collocated scenario and, additionally, the terminal device 10 also supports the non-collocated scenario. Moreover, an RRC connection is established between the terminal device 10 and the base station device 50. For example, the terminal device 10 and the base station device 50 transmit and receive RRC messages in their RRC layer to proceed with session processing (also called a connection sequence). The above-described prerequisite of Example 1 of the radio signal transmission processing also applies to Example 2 of the radio signal transmission processing described later.

Referring to FIG. 5, for example, the base station device 50-1 (one base station device) among the plurality of base station devices 50 transmits “UECapabilityEnquriry” to the terminal device 10 to enquire about the terminal capability information “UECapabilityInformation” of the terminal device 10 (step S1).

The terminal device 10 returns (or reports) its own terminal capability information “UECapabilityInformation” to the base station device 50-1 in response to the enquiry from the base station device 50-1 (“UECapabilityEnquriry”) (step S3A).

For example, the terminal device 10 notifies the base station device 50-1 of the availability information indicating that the plurality of MIMO methods (for example, the 2×2 MIMO method and the 4×4 MIMO method) with the different maximum numbers of layers which are available to the terminal device 10 can be used. This availability information includes Information I1 about the maximum number of layers for each of the plurality of MIMO methods with the different maximum numbers of layers which are available to the terminal device 10. More specifically, Information I1 about the maximum number of layers for each of the plurality of MIMO methods with the different maximum numbers of layers which are available to the terminal device 10 includes the following information indicated in FIG. 5.

[Information I1]
intraBandMRDC-WithOverlapDL-Bands-maxNumberMIMO-LayersPDSCH
:: = ENUMERATED {twoLayers, fourLayers}

In the above information, “twoLayers” indicates the 2×2 MIMO method regarding which the maximum number of layers is 2, and “fourLayers” indicates the 4×4 MIMO method regarding which the maximum number of layers is 4. Specifically speaking, this Information I1 indicates that the terminal device 10 supports the 2×2 MIMO method and the 4×4 MIMO method.

The base station device 50-1 sets, for example, the MIMO layer of each CC upon the downlink CA based on based on the terminal capability information of the terminal device 10, which has been received from the terminal device 10, and transmits it to (or shares it with) another base station device(s) 50-n which supports the non-collocated scenario (step S5). Since the terminal device 10 can use the plurality of MIMO methods, that is, the 2×2 MIMO method and the 4×4 MIMO method, the base station device 50-1 can select the 4×4 MIMO method which makes it possible to expand the communication bandwidth more. The base station device 50-1 sets the MIMO layer for each CC based on the selected 4×4 MIMO method. Since the base station device 50-1 can communicate with the other base station device(s) 50-n which support the non-collocated scenario, the base station device 50-1 transmits the information about the set MIMO layer of each CC upon the downlink CA to the other base station device(s) 50-n.

Next, the base station device 50-1 transmits the information about the set MIMO layer of each CC upon the downlink CA, as “RRCReconfiguration,” to the terminal device 10 (step S7). Moreover, the base station device 50-1 may allocate a radio resource for the uplink based on the terminal capability information of the terminal device 10 which has been received from the terminal device 10.

Incidentally, the timing for the base station device 50-1 to share setting information with the other base station device(s) 50-n is arbitrary. The setting information may be transmitted to the other base station device(s) 50-n every time the base station device 50-1 sets and generates the setting information; or the setting information may be transmitted upon a request from the other base station device(s) 50-n.

The base station device 50-1 transmits the radio signal to the terminal device 10 by using the set MIMO method (step S9). For example, the base station device 50-1 executes access control processing (for example, CA processing and MIMO processing for the downlink) for transmitting the radio signal to the terminal device 10. Incidentally, the setting information is shared with the other base station device(s) 50-n by the base station device 50-1 as described above. Consequently, similarly to the base station device 50-1, the other base station device(s) 50-n can transmit the radio signal to the terminal device 10 by using the MIMO method set by the base station device 50-1.

According to Example 1 of the radio signal transmission processing as described above, the terminal device 10 accepts the enquiry about the capability information of the terminal device from one base station device 50-1 among the plurality of base station devices 50. For example, when the terminal device 10 supports the non-collocated scenario, the terminal device 10 notifies one base station device 50-1 of the availability information indicating that the plurality of MIMO methods with the different maximum numbers of layers available to the terminal device 10 can be used, as the terminal capability information, based on the enquiry from the base station device 50-1. Particularly, in Example 1 of the radio signal transmission processing, the terminal device 10 notifies the base station device 50-1 of Information I1 about the maximum number of layers for each of the plurality of MIMO methods. The terminal device 10 receives the radio signal which is transmitted by using the MIMO method which is set by the one base station device 50-1 based on the terminal capability information.

Accordingly, the base station device 50-1 can set an appropriate MIMO method to be used for the radio communication with the terminal device 10 based on Information I1 about the maximum number of layers for each of the plurality of MIMO methods available to the terminal device 10 and can execute appropriate scheduling according to the set MIMO method. Then, the terminal device 10 can receive the radio signal transmitted based on the radio resource appropriately allocated from the base station device 50-1. Therefore, it is possible to enhance the utilization efficiency of radio communication resources between the terminal device 1 and the plurality of base station devices 50.

### Variation of Example 1

An explanation will be provided about a variation of Example 1 of the radio signal transmission processing of the terminal device according to the embodiment with reference to FIG. 6. In the variation of Example 1 of the radio signal transmission processing, the terminal device 10 notifies the base station device 50-1 of information indicating the plurality of MIMO methods with the different maximum numbers of layers which are available to the terminal device, as the terminal capability information. The difference from Example 1 of the radio signal transmission processing will be explained in detail below.

Referring to FIG. 6, the terminal device 10 notifies the base station device 50-1 of Information I2 indicating the plurality of MIMO methods with the different maximum numbers of layers available to the terminal device 10 (step S3B). More specifically, Information I2 indicating the plurality of MIMO methods with the different maximum numbers of layers available to the terminal device 10 includes the following information indicated in FIG. 6.

[Information I2]
intraBandMRDC-WithOverlapDL-Bands-4Layers
:: = ENUMERATED {Supported}

In the above information, “ . . . 4Layers” indicates the 4×4 MIMO method, that is, the maximum number of layers is 4. Specifically speaking, Information I2 indicates that the terminal device 10 supports at least the 4×4 MIMO method. Then, the fact that the terminal device 10 supports the 4×4 MIMO method indicates that the terminal device 10 also supports the 2×2 MIMO method which is a subordinate method of the 4×4 MIMO method. Therefore, this Information I2 indicates that the terminal device 10 supports the 2×2 MIMO method and the 4×4 MIMO method.

According to the variation of Example 1 of the radio signal transmission processing, the base station device 50-1 can set an appropriate MIMO method to be used for the radio communication with the terminal device 10 based on Information I2, which indicates the plurality of MIMO methods with the different maximum number of layers available to the terminal device 10, and can execute appropriate scheduling according to the set MIMO method. Then, the terminal device 10 can receive the radio signal which is transmitted based on the radio resource appropriately allocated from the base station device 50-1. Therefore, it is possible to enhance the utilization efficiency of radio communication resources between the terminal device 1 and the plurality of base station devices 50.

### Example 2

An explanation will be provided about Example 2 of the radio signal transmission processing of the terminal device according to the embodiment with reference to FIG. 7. In Example 2 of the radio signal transmission processing, the terminal device 10 notifies the base station device 50-1 of type information indicating that it is a terminal device of a specific type capable of using a plurality of MIMO methods, as the terminal capability information. The difference from Example 1 of the radio signal transmission processing will be explained in detail below.

Referring to FIG. 7, the terminal device 10 notifies the base station device 50-1 of type information I3 indicating that it is a terminal device of a specific type capable of using a plurality of MIMO methods (step S3C). More specifically, the type information I3 includes the following information indicated in FIG. 7.

[Information I3]
intraBandMRDC-WithOverlapDL-Bands-r18
:: = {supported}

In the above information, “intraBandMRDC-WithOverlapDL-Bands-r18” indicates that it is a terminal device of a specific type which can use the 4×4 MIMO method (in addition to the 2×2 MIMO method) for each CC and supports the non-collocated scenario. Moreover, “intraBandMRDC-WithOverlapDL-Bands-r18” is in a signaling form similar to that of conventional “intraBandMRDC-WithOverlapDL-Bands-r16” which indicates that it is a terminal device which can use the 2×2 MIMO method for each CC and supports the non-collocated scenario (conventional signaling), but is defined as new signaling.

According to Example 2 of the radio signal transmission processing, the base station device 50-1 can set an appropriate MIMO method to be used for the radio communication with the terminal device 10 based on the type information, which indicates that it is a terminal device of a specific type capable of using the plurality of MIMO methods, and can execute appropriate scheduling according to the set MIMO method. Then, the terminal device 10 can receive the radio signal which is transmitted based on the radio resource appropriately allocated from the base station device 50-1. Therefore, it is possible to enhance the utilization efficiency of radio communication resources between the terminal device 1 and the plurality of base station devices 50. Particularly, according to Example 2, the radio communication system 100 has advantageous effects similar to those of Example 1 by using the new signaling, even though it is in a signaling form similar to that of the conventional signaling.

### Variation of Example 2

An explanation will be provided about a variation of Example 2 of the radio signal transmission processing of the terminal device according to the embodiment with reference to FIG. 8. In Example 2 of the radio signal transmission processing, the new signaling is defined separately, while the content of the conventional signaling is changed in the variation of Example 2 of the radio signal transmission processing. The difference from Example 2 of the radio signal transmission processing will be explained in detail below.

Referring to FIG. 8, the terminal device 10 notifies the base station device 50-1 of type information I4 indicating that it is a terminal device of a specific type capable of using a plurality of MIMO methods (step S3D). More specifically, the type information I4 includes the following information indicated in FIG. 8.

[Information I4]
intraBandMRDC-WithOverlapDL-Bands-r16
:: = {Type 1, Type 2, Type 3}

In the above information, “Type 3” (Type 3 UE) indicates that it is a terminal device of a specific type which can use the 4×4 MIMO method, in addition to the 2×2 MIMO method, for each CC and supports the non-collocated scenario. Incidentally, “Type 1” (Type 1 UE) indicates that it is a terminal device which supports the collocated scenario; and “Type 2” (Type 2 UE) indicates that it is a terminal device which can use the 2×2 MIMO method for each CC and supports the non-collocated scenario.

Accordingly, the terminal device 10 can report Information I4 to which “Type 3” that is a type of the specific terminal device, i.e., a specific type which can use the 4×4 MIMO method for each CC and supports the non-collocated scenario is added to the conventional “intraBandMRDC-WithOverlapDL-Bands-r16.”

According to the variation of Example 2 of the radio signal transmission processing, the base station device 50-1 can set an appropriate MIMO method to be used for the radio communication with the terminal device 10 based on the type information, which indicates that it is a terminal device of the specific type capable of using the plurality of MIMO methods, and can execute appropriate scheduling according to the set MIMO method. Then, the terminal device 10 can receive the radio signal transmitted based on the radio resource appropriately allocated from the base station device 50-1. Therefore, it is possible to enhance the utilization efficiency of radio communication resources between the terminal device 1 and the plurality of base station devices 50. Particularly, according to the variation of Example 2, the radio communication system 100 has advantageous effects similar to those of Example 1 by using signaling obtained by adding a change to the content of the conventional signaling.

Each embodiment or example described above is intended to facilitate understanding of the present invention and is not intended to interpret the present invention in a limited manner. The present invention can be changed/improved without departing from the gist thereof and the invention also includes its equivalents. Moreover, the present invention can form various disclosures by appropriately combining a plurality of constituent elements disclosed in the respective embodiments or the respective examples described above. For example, some constituent elements may be deleted from all the constituent elements indicated in the embodiments. Furthermore, the constituent elements of different embodiments may be combined together as appropriate.

### REFERENCE SIGNS LIST

10 (10-1 . . . 10-m) terminal device(s)
11 acceptance unit
13 notification unit
15 receiving unit
21 processor
22 memory
23 storage apparatus
24 communication apparatus
25 input apparatus
26 output apparatus
27A, 27B antennas
29 sensor
50 (50-1 . . . 50-n) base station device(s)
51 enquiry unit
53 setting unit
55 transmission unit
90 core network apparatus
100 radio communication system

1. A terminal device capable of radio communication with a plurality of base station devices, the terminal device comprising:
an acceptance unit that accepts an enquiry about capability information of the terminal device from one base station device among the plurality of base station devices;
a notification unit that, when the terminal device can communicate with the plurality of base station devices located at different positions, notifies the one base station device of availability information indicating that a plurality of MIMO methods with different maximum numbers of layers which are available to the terminal device can be used, as the capability information, based on the enquiry; and
a receiving unit that receives a radio signal transmitted from the one base station device by using a MIMO method which is set based on the capability information.

2. The terminal device according to claim 1,
wherein the notification unit notifies the plurality of base station devices of information about a maximum number of layers regarding each of the plurality of MIMO methods as the availability information.

3. The terminal device according to claim 1,
wherein the notification unit notifies the plurality of base station devices of information indicating the plurality of MIMO methods as the availability information.

4. The terminal device according to claim 1,
wherein the notification unit notifies the plurality of base station devices of type information indicating that the terminal device is a terminal device of a specific type capable of using the plurality of MIMO methods, as the availability information.

5. A radio communication method executed by a terminal device capable of radio communication with a plurality of base station devices,
the radio communication method comprising:
accepting an enquiry about capability information of the terminal device from one base station device among the plurality of base station devices;
when the terminal device can communicate with the plurality of base station devices located at different positions, notifying the one base station device of availability information indicating that a plurality of MIMO methods with different maximum numbers of layers which are available to the terminal device can be used, as the capability information, based on the enquiry; and
receiving a radio signal transmitted from the one base station device by using a MIMO method which is set based on the capability information.
